(19) United States
(12) Patent Application Publication
(10) Pub. No.: US 2013/0091525 A1
(43) Pub. Date: Apr. 11, 2013

(54) METHOD AND APPARATUS FOR PROVIDING CLOUD-BASED USER MENU

(71) Applicants: ELECTRONICS AND TELECOMMUNICATIONS R, Daejeon-si (KR); KT CORPORATION, Gyeonggi-do (KR)

(72) Inventors: Chang-Woo YOON, Daejeon-si (KR); Il-Hong SHIN, Daejeon-si (KR); Bo-Yun EOM, Daejeon-si (KR); Eun-Jung KWON, Daejeon-si (KR); Eun-Jun RHEE, Daejeon-si (KR); Hyun-Woo LEE, Daejeon-si (KR); Won RYU, Daejeon-si (KR); Gyu-Tae BAEK, Seoul (KR); Su-Ho PARK, Seoul (KR)

(73) Assignees: KT CORPORATION, Gyeonggi-do (KR); ELECTRONICS AND TELECOMMUNICATIONS RESEARCH INSTITUTE, Daejeon-si (KR)

(21) Appl. No.: 13/645,836

(22) Filed: Oct. 5, 2012

(30) Foreign Application Priority Data
Oct. 7, 2011 (KR) 10-2011-0102685
Jun. 19, 2012 (KR) 10-2012-0065732

(51) Int. Cl. H04N 21/431

(52) U.S. Cl. 725/52

(57) ABSTRACT

A method and an apparatus for providing a cloud-based user menu are provided. The method and the apparatus for providing a cloud-based user menu according to an exemplary embodiment of the present invention is separately structured such that a cloud server connected to a broadcast receiving terminal configures the user menu and the broadcast receiving terminal merely renders the user menu when digital broadcasting is provided.

### CROSS-REFERENCE TO RELATED APPLICATION

This application claims the benefit under 35 U.S.C. §119(a) of Korean Patent Application Nos. 10-2011-0102685, filed on Oct. 7, 2011, and 10-2012-0065732, filed on Jun. 19, 2012, the entire disclosures of which are incorporated herein by references for all purposes.

### BACKGROUND

1. Field

The present invention relates to a method for providing a user interface, and more particularly, to a method for providing a user interface or user experience in a digital broadcasting system.

2. Description of the Related Art

With the rapid transition from analog to digital broadcasting, much more content is demanded for digital broadcasting than analogue broadcasting, and the types of such content are varied. The types of digital broadcasting may include terrestrial broadcasting, content broadcasting, real-time broadcasting, bi-directional service and Video on Demand (VOD).

A user menu is required to provide a user with these types of content systematically. Without the user menu, it is difficult to find a desired content among such abundant content. The user menu has been developed from a simple text-type menu into a sophisticated one using graphics. In particular, demands for three-dimensional (3D) content which looks more real and stereoscopic than two-dimensional (2D) content are increasing recently.

Generally, the user menu is configured through an application program of a Set-Top Box (STB) as a broadcast receiving terminal and displayed on a screen of a digital TV connected to the broadcast receiving terminal. In this case, it is not easy to change a default user menu that is initially installed in the terminal or to provide a user menu personalized for the user's preferences. In addition, it is even harder to configure a 3D stereoscopic menu with high definition.

### SUMMARY

According to an exemplary embodiment of the present invention, a method and an apparatus for providing a cloud-based user menu to flexibly process the user menu in a digital broadcasting system are provided.

A method for displaying a user menu in a broadcast receiving terminal in a digital broadcasting system includes receiving a user menu configured through a cloud server and rendering the user menu received from the cloud server in a digital TV.

A method for providing a user menu in a cloud server according to another exemplary embodiment of the present invention includes configuring the user menu in a cloud using a menu behavior pattern and providing the user menu for a broadcast receiving terminal connected to a digital TV.

The cloud server according to another exemplary embodiment includes a menu configuring unit configured to configure the user menu in the cloud using the menu behavior pattern and a menu providing unit configured to provide the broadcast receiving terminal with the user menu configured through the menu configuring unit.

The digital broadcasting system according to another exemplary embodiment of the present invention includes the cloud server configured to configure the user menu using the menu behavior pattern, the broadcast receiving terminal configured to receive the configured user menu from the cloud server to be rendered in the digital TV and a resource server configured to provide resources necessary for the cloud server to configure the user menu and for the broadcast receiving terminal to render the user menu.

According to an exemplary embodiment of the present invention, a separately-structured model of the present invention may maximize the flexibility of a method for processing a menu, resulting in those for easily providing a personalized menu, conveniently replacing a menu and configuring an independent menu on a terminal.

### BRIEF DESCRIPTION OF THE DRAWINGS

FIG. 1 is a diagram illustrating a configuration of a digital broadcasting system according to an exemplary embodiment of the present invention;

FIG. 2 is a diagram illustrating in detail a configuration of the digital broadcasting system shown in FIG. 1;

FIG. 3 is a diagram illustrating a configuration of a cloud server according to an exemplary embodiment of the present invention;

FIG. 4 is a diagram illustrating a configuration of a broadcast receiving terminal according to an exemplary embodiment of the present invention;

FIG. 5 is a reference diagram illustrating a method for configuring a cloud-based separately-structured stereoscopic menu according to an exemplary embodiment of the present invention;

FIG. 6 is a diagram illustrating a configuration of a digital broadcasting system for providing a user menu associated with an advertisement according to another exemplary embodiment of the present invention;

FIG. 7 is a diagram illustrating a configuration of a digital broadcasting system for providing a user menu through an N screen according to another exemplary embodiment of the present invention; and

FIG. 8 is a flowchart illustrating a process performed by each of configurations of a digital broadcasting system 1 for providing a user menu according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is delivered to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

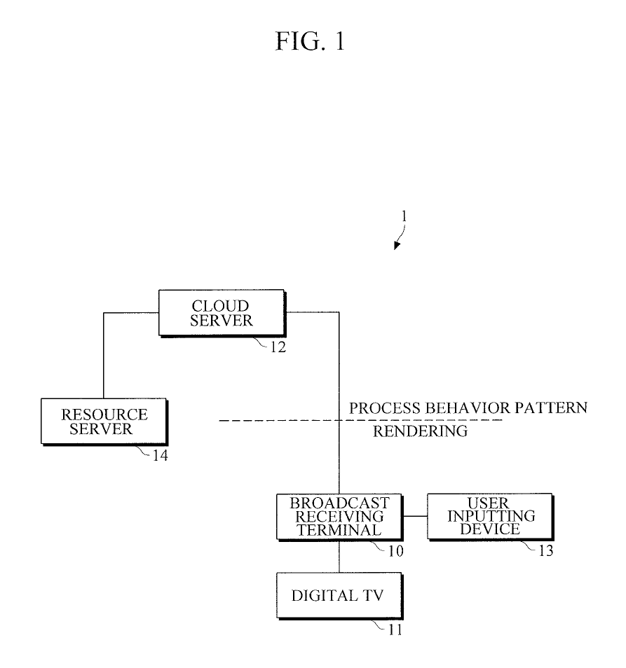

FIG. 1 is a diagram illustrating a configuration of a digital broadcasting system 1 according to an exemplary embodiment of the present invention.

Referring to FIG. 1, the digital broadcasting system 1 includes a broadcast receiving terminal 10, a digital TV 11, a cloud server 12, a user inputting device 13 and a resource server 14.

The digital broadcasting system 1 converts broadcast data into digital data through the broadcast receiving terminal 10 and provides the digital data for viewers through the digital TV 11 so that, compared to analogue, clearer and more vivid video data is provided. The digital TV 11 has been developed into a Digital Cable TV, an Internet Protocol TV (IPTV) and a Smart TV, which have in common a capability of helping a broadcast service provider and a service user to interact with each other using bi-directional characteristics of the Internet.

The present invention is separately-structured such that, when a digital broadcast service is provided in the digital broadcasting system 1, the cloud server 12 in the cloud configures a user menu to be displayed on a screen and the broadcast receiving terminal 10 merely renders the user menu.

The user menu refers to a menu corresponding to a User Interface (UI) or a User Experience (UX). The user menu may be Electronic Program Guide (EPG) information or Interactive Program Guide (IPG) information such as a TV program log to help a user to search for a desired program with reference to time, title, channel and genre.

According to an exemplary embodiment of the present invention, the user menu may be a three-dimensional (3D) stereoscopic image. In this case, the broadcast receiving terminal 10 is generates the 3D stereoscopic image by performing a rendering and outputs the 3D stereoscopic image to the digital TV 11.

In another example, the user menu may display upper content, such as My Menu registered by the user, real-time broadcasting, bi-directional service and VOD, and a channel of each of the upper content. Herein, the channel refers to lower content. If a channel is selected by an input command of the user inputting device 13, one of the lower content corresponding to the channel is displayed and, if none of the lower content corresponds to the channel, detailed content corresponding to the channel may be displayed.

My Menu is a menu for user's favorite content; a real-time broadcasting menu is a menu for channels of terrestrial broadcasting, home-shopping, movie and other real-time broadcastings; bi-directional service menu is menu for games, shopping, singing, living information and any other additional services; and VOD menu is a menu for various types of VODs including movie, foreign soap-operas, terrestrial broadcasting, education and sports to be watched using a streaming or Down-and-Play (D&P) service.

The user menu may include a user's favorite channel, a previously-viewed channel, a watch history and a user-defined channel and be manipulated by a user command of the user inputting device 13. The user menu may be positioned in a region which the user designates on a screen of the digital TV 11.

According to the present invention, the user menu is configured not by the broadcast receiving terminal 10 but by the cloud server 12 connected to the broadcast receiving terminal 10 via a network, and the broadcast receiving terminal 10 simply receives the user menu from the cloud server 12. In other words, it is separately structured such that the cloud server 12 performs almost all of the processes to provide the user menu and the broadcast receiving terminal 10 merely renders the user menu. The separately-structured model of the present invention may maximize the flexibility of a method for processing a menu, resulting in those for easily providing a personalized menu, conveniently replacing a menu and configuring an independent menu in a terminal. Hereinafter, detailed configurations of the digital broadcasting system 1 characterized as above will be provided.

The user inputting device 13 receives a service request signal, a menu selection signal or a TV control signal from a user to be transmitted to the broadcast receiving terminal 10. For example, the user inputting device 13 may be a remote controller.

The cloud server 12 receives from the broadcast receiving terminal 10 the service request signal or a menu selection signal input by a user through the user inputting device 13, implements the requested service and provides result data of the implementation to the broadcast receiving terminal 10. The cloud server 12 may be connected to a broadcast data transmitting server (Not Shown) via an Internet network.

The cloud server 12 configures the user menu using a menu behavior pattern in the cloud and provides the configured a user menu for the broadcast receiving terminal 10. The menu behavior pattern includes a user menu skeleton, menu configuration data and menu control information. For example, the menu skeleton may include a structure of menu categories (upper and lower content and channels) and a region in which the user menu is to be displayed. The menu skeleton may be a tree structure made of upper and lower content and channels.

The broadcast receiving terminal 10 functions as a general Set-Top Box (STB). In other words, the broadcast receiving terminal 10 receives broadcast data from the broadcast data-transmitting server and outputs the broadcast data to the digital TV 11. The broadcast receiving terminal 10 may be embedded in the digital TV 11 or disposed outside of the digital TV 11.

The broadcast receiving terminal 10 is connected to the cloud server 12 via an Internet network. A plurality of the broadcast receiving terminals 10 may be provided and simultaneously connected to the cloud server 12. The broadcast receiving terminal 10 receives a service request signal, a menu selection signal or a TV control signal of the user inputting device 13 to control the digital TV 11. In another example, the broadcast receiving terminal 10 transmits an input command of the user inputting device 13 to the cloud server 12 and receives data from the cloud server 12 to be output to the screen of the digital TV 11.

The resource server 14 provides resources necessary for the cloud server 12 to configure the user menu and for the broadcast receiving terminal 10 to render the user menu. The resource includes text data, a menu image and video information.

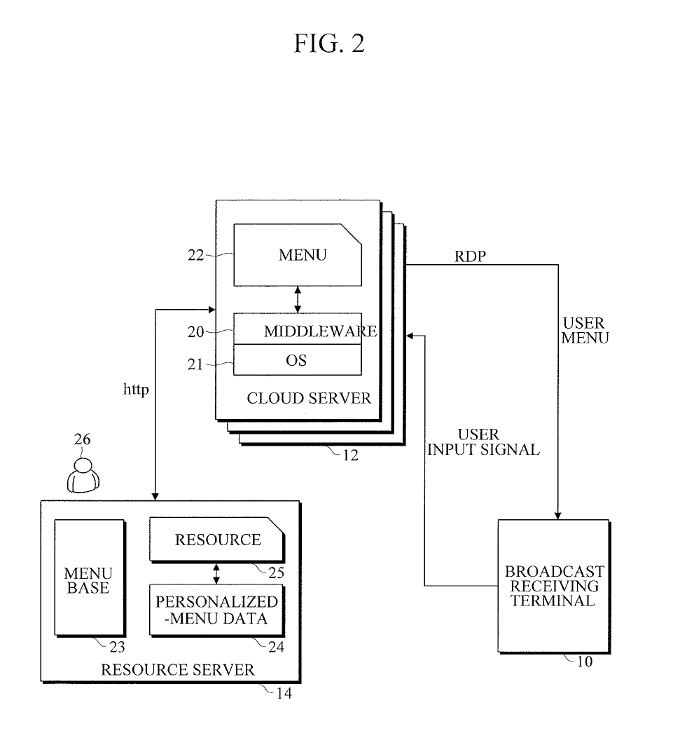

FIG. 2 is a diagram illustrating in detail the digital broadcasting system 1 shown in FIG. 1.

Referring to FIGS. 1 and 2, the cloud server 12 includes a middleware 20 and an operating system (OS) 21.

The OS 21 of the cloud server 12 supports multi-session. The multi-session means that a plurality of the broadcast receiving terminals 10 are able to be connected to the cloud server 12. The middleware 20 implements the user menu 22, and specifically, if a user command, such as inputting of a menu button, is received from a user through the user inputting device 13, the middleware 20 receives the user command from the broadcast receiving terminal 10 to implement the menu.

If the menu is implemented, the middleware 20 receives menu behavior pattern information from a menu base 23 of the resource server 14. The behavior pattern information includes a menu skeleton and menu control information. The behavior pattern information of the menu base 23 has the same skeleton with respect to each user. Meanwhile, the middleware 20 receives personalized-menu data 24 of the corresponding session from the resource server 14. The personalized-menu data 24 has a different menu skeleton with respect to each user. The personalized-menu data 24 includes a user's favorite channel, a list of watched VODs, a watch history and a user-defined channel.

According to an exemplary embodiment of the present invention, the middleware 20 combines the behavior pattern information of the menu base 23 and the personalized-menu data 24 so as to configure the user menu 22 for the broadcast receiving terminal 10 and provides the broadcast receiving terminal 10 with the configured user menu 22. Remote Desktop Protocol (RDP) may be used for providing the user menu 22 for the broadcast receiving terminal 10. The resource 25 necessary for configuring the user menu by the middle ware 20 and for rendering the user menu by the broadcast receiving terminal 10 may be provided to the broadcast receiving terminal 10 through the resource server 14 in real-time. For example, the resource 25 is provided in a manner that, if the broadcast receiving terminal 10 requests the resource 25 from the middleware 20 using the RDP, the middleware 20 connected to the resource server 14 receives the resource 25 from the resource server 14 using HTTP and provides the resource 25 for the broadcast receiving terminal 10. The resource 25 may include text data of the menu, a menu image and a video menu.

A menu operator/editor 26 may edit the menu base 23 in real-time using a menu editing device. Since the menu base 23 is updated through the user menu 22 of the cloud server 12 whenever the broadcast receiving terminal 10 is turned-on, it is easy to reflect a change in the menu in real time. In other words, if all menu data is processed in the broadcast receiving terminal 10, a complex procedure is required to change the menu, but, according to the present invention, the menu data may be updated in real-time through the user menu 22 of the cloud server 12.

As described above, the present invention is separately structured such that the cloud server 12 processes a menu behavior pattern and the broadcast receiving terminal 10 merely renders the menu when a user menu is provided using cloud techniques in the digital broadcasting system 1. Due to the separate structure of the present invention, the broadcast receiving terminal 10 merely renders the menu so that the flexibility of the menu processing method may be maximized, resulting in those for easily providing a personalized menu, conveniently replacing a menu and configuring an independent menu in the terminal.

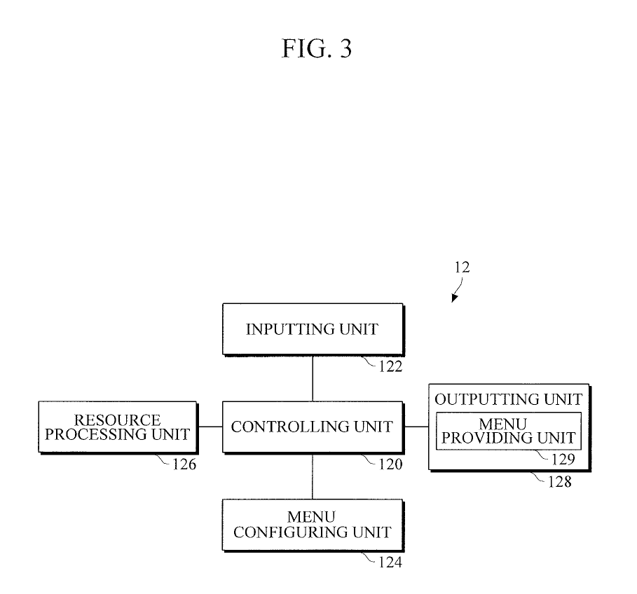

FIG. 3 is a diagram illustrating a configuration of the cloud server 12 according to an exemplary embodiment of the present invention.

Referring to FIGS. 1 and 3, the cloud server 12 includes a controlling unit 120, an inputting unit 122, a menu configuring unit 124, a resource processing unit 126 and an outputting unit 128 including the menu providing unit 129.

The controlling unit 120 controls an overall operation of the cloud server 12, and specifically, the inputting unit 122, the menu configuring unit 124, the resource processing unit 126 and the menu providing unit 129, of which the cloud server 12 is made.

The inputting unit 122 receives from the broadcast receiving terminal 10 a predetermined signal or data, and specifically, a service request signal, a menu selection signal or a TV control signal input by a user through the user inputting device 13.

The menu configuring unit 124 configures the user menu in a cloud using a menu behavior pattern. The user menu may be a 3D stereoscopic image. The behavior pattern of the menu may include a user menu skeleton, menu configuration data and menu control information.

The menu configuring unit 124 may configures the user menu by combining behavior pattern information of the menu and personalized-menu data. According to an exemplary embodiment of the present invention, if the broadcast receiving terminal 10 is turned on, the menu providing unit 129 simultaneously provides the broadcast receiving terminal 10 with the menu behavior pattern information and the personalized-menu data. In another example, if the broadcast receiving terminal 10 is turned on, the menu providing unit 129 provides the broadcast receiving terminal 10 with the menu behavior pattern information, and, if a user input signal is received from the broadcast receiving terminal 10 when the broadcast receiving terminal 10 is being implemented, the menu providing unit 129 provides the broadcast receiving terminal 10 with the personalized-menu data.

The resource processing unit 126 receives from the resource server 14 the resource necessary for configuring the user menu. The resource includes text data, a menu image and video information.

The outputting unit 128 outputs a predetermined signal or data, and the menu providing unit 129 of the outputting unit 128 provides the broadcast receiving terminal 10 with the user menu configured through the menu configuring unit 124.

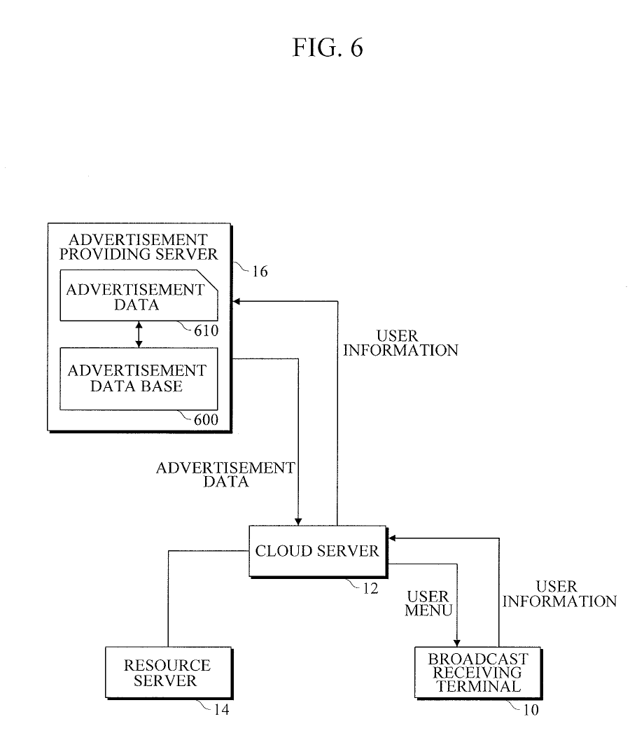

According to an exemplary embodiment of the present invention, the menu configuring unit 124 configures a different user menu for each display apparatus, and the menu providing unit 128 provides each display apparatus with the different user menu. A relevant exemplary embodiment will be explained in accompanying with FIG. 6.

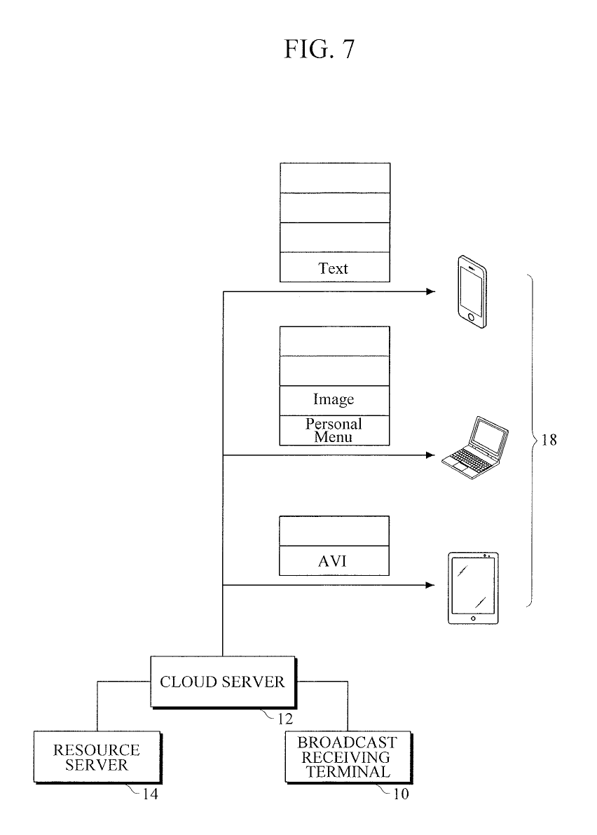

According to an exemplary embodiment of the present invention, the inputting unit 122 receives user information from the broadcast receiving terminal 10 and provides the user information for an advertisement-providing server through the outputting unit 128. If the advertisement-providing server selects user-targeted advertisement data based on the user information, the user-targeted advertisement data selected by the advertisement-providing server is received through the inputting unit 122. The menu configuring unit 124 combines the user-targeted advertisement data with the user menu, and the menu providing unit 128 provides the broadcast receiving terminal 10 with the user menu combined with the user-targeted advertisement data. A relevant exemplary embodiment will be explained in accompanying with FIG. 7.

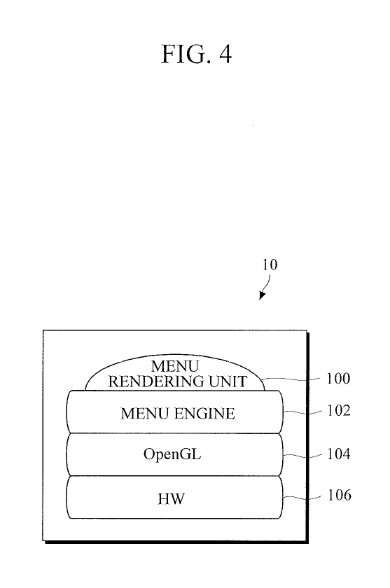

FIG. 4 is a diagram illustrating a configuration of the broadcast receiving terminal 10 according to an exemplary embodiment of the present invention.

Referring to FIGS. 1 and 4, the broadcast receiving terminal 10 includes a menu-rendering unit 100, which includes a menu engine 102, an Open Graphics Library (OpenGL) 104 and a hardware 106.

The broadcast receiving terminal 10 acts as a STB to receive digital broadcast. The STB function of the broadcast receiving terminal 10 is based on well-known techniques and is not a key technology of the present invention, so configurations of the broadcast receiving terminal 10 will be explained mainly about a menu-rendering function in the present invention.

The menu rendering unit 100 performs a menu rendering using a menu behavior pattern and a menu resource which are necessary for the menu rendering. According to a rendering process, the menu rendering is performed by the menu engine 102 configured to render the menu, and the rendered menu is painted on a graphic board of the hardware 106 using the OpenGL 104. At this time, the menu engine 102 may render a 3D stereoscopic menu.

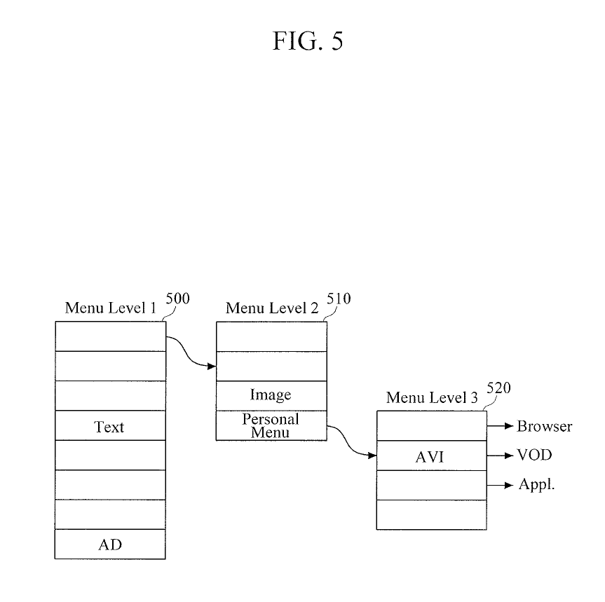

FIG. 5 is a reference diagram illustrating a method for configuring a cloud-based separately-structured stereoscopic menu according to an exemplary embodiment of the present invention.

Referring to FIG. 5, the broadcast receiving terminal 10 receives a menu all at once or in phases.

According to an exemplary embodiment of the present invention, the broadcast receiving terminal 10 receives a menu from the cloud server 12 all at once. For example, if a menu is configured in three phases as shown in FIG. 5, the broadcast receiving terminal 10 downloads behavior pattern information about the three-phase menus 500, 510 and 520 from the resource server 14 through the cloud server 12, when turned on. In addition, only the personalized-menu data is downloaded from the resource server 14, if necessary. The above method makes it easy to configure and implement an entire menu.

In another example, the broadcast receiving terminal 10 receives a menu from the cloud server 12 in phases. For example, if the broadcast receiving terminal 10 is turned on, a menu of the menu level 1 500 is downloaded from the resource server 14 and, if an input signal is received from a user, a menu of the menu level 2 510 is downloaded from the resource server 14. The above method may be useful when the broadcast receiving terminal 10 does not have sufficient capacity for the entire menu to be downloaded.

FIG. 6 is a diagram illustrating a configuration of a digital broadcasting system 1 for providing a user menu in association with an advertisement according to another exemplary embodiment of the present invention.

Referring to FIGS. 1 and 6, the digital broadcasting system 1 further includes an advertisement-providing server 16 in addition to the configurations as shown in FIG. 1. The advertisement-providing server 16 is operated by a service provider or an advertiser and may store advertisement data in advertisement database 600 to search for predetermined advertisement data in the advertisement database 600. The costs of the advertisement data may have been paid by the advertiser based on a contract. If the user information is provided to the advertisement-providing server 16 through the cloud server 12 when the broadcast receiving terminal 10 is turned on, the advertisement-providing server 16 performs a search in the advertisement database 600 to select advertisement data suitable for a user and transmits the selected advertisement data 610 to the cloud server 12. The cloud server 21 inserts the selected advertisement data into an appropriate region of the user menu and provides the selected advertisement data 610 for the broadcast receiving terminal 10, and the broadcast receiving terminal 10 provides the selected advertisement data 610 for the user through the digital TV 11.

FIG. 7 is a diagram illustrating a configuration of the digital broadcasting system 1 for providing a user menu through an N screen according to another exemplary embodiment of the present invention.

Referring to FIGS. 1 and 7, the digital broadcasting system 1 further includes a display apparatus 18 capable of reproducing broadcast content in addition to the configurations shown in FIG. 1. The display apparatus 18 includes all types of electronic apparatus capable of reproducing broadcast content to be displayed. For example, the display apparatus 18 may be a portable terminal such as a smart phone, a smart pad, a laptop computer and a Personal Digital Assistant (PDA). A serviced screen output to the digital TV 11 connected to the broadcast receiving terminal 10 is simultaneously output to the display apparatus 18. In another example, a control screen is output on the display apparatus 18 so as to control the screen while watching the screen so that a menu on the control screen may be selected using an interface such as a touch screen.

In the present invention, the cloud server 12 may configure a distinctive user menu for each display apparatus and provide each display apparatus with the distinctive user menu. For example, as shown in FIG. 7, it is possible to provide a text-type menu for a smart phone, menu images and personalized-menu data for a laptop computer, and a video menu for a smart pad. Accordingly, the cloud server 12 may configure a user menu according to a type of a display apparatus so that it is easy to configure the user menu according to each of various types of an N screen.

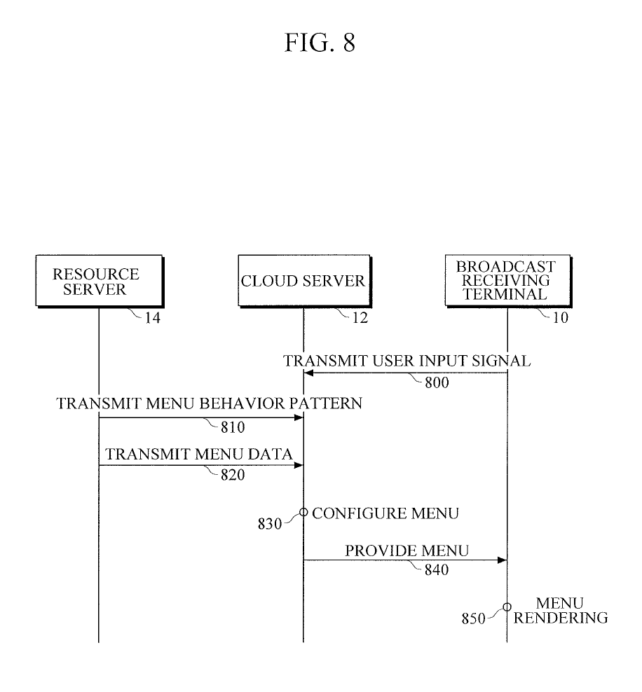

FIG. 8 is a flowchart illustrating a process performed by configurations of the digital broadcasting system 1 for providing a user menu according to an exemplary embodiment of the present invention.

Referring to FIGS. 1 and 8, the broadcast receiving terminal 10 transmits a user input signal received from the user inputting device 13 to the cloud server 12 in 800. The cloud server 12 receives menu behavior pattern information and personalized-menu data from the resource server 14 in 810 and 820. The cloud server 12 configures a user menu by combining the menu behavior pattern information and the personalized-menu data to in 830. The cloud server 12 provides the configured user menu for the broadcast receiving terminal 10 in 840. The broadcast receiving terminal 10 renders the received user menu and provides the user menu for the digital TV 11 in 850.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for displaying a user menu in a broadcast receiving terminal in a digital broadcasting system, comprising:
receiving a user menu configured through a cloud server; and
rendering the user menu received from the cloud server in a digital TV.

2. The method of claim 1, wherein the user menu is a three-dimensional (3D) stereoscopic image.

3. A method for providing a user menu in a cloud server in a digital broadcasting system, comprising:
configuring a user menu in a cloud using a menu behavior pattern; and
providing the user menu for a broadcast receiving terminal connected to a digital TV.

4. The method of claim 3, wherein the user menu is a 3D stereoscopic image.

5. The method of claim 3, wherein the menu behavior pattern comprises a user menu skeleton, menu configuration data and menu control information.

6. The method of claim 3, wherein the configuring of the user menu comprises configuring the user menu by combining menu behavior pattern information and personalized-menu data.

7. The method of claim 3, wherein the configuring of the user menu comprises, in response to the broadcast receiving terminal being turned on, simultaneously providing the broadcast receiving terminal with the menu behavior pattern information and the personalized-menu data.

8. The method of claim 3, wherein the configuring of the user menu comprises, in response to the broadcast receiving terminal being turned on, providing the broadcast receiving terminal with the menu behavior pattern information and, in response to reception of a user input signal from the broadcast receiving terminal when the broadcast receiving terminal is being implemented, providing the broadcast receiving terminal with the personalized-menu data.

9. The method of claim 3, wherein the configuring of the user menu comprises configuring a different user menu for each display apparatus to display the user menu and the method further comprises providing the each display apparatus with the different user menu.

10. The method of claim 3, further comprising:
receiving user information from the broadcast receiving terminal to be provided to an advertisement-providing server; and
receiving user-targeted advertisement data selected based on the user information from the advertisement providing server,
wherein the configuring of the user menu comprises combining the user-targeted advertisement data with the user menu.

11. A cloud server, comprising:
a menu configuring unit configured to configure a user menu in a cloud using a menu behavior pattern; and
a menu providing unit configured to provide a broadcast receiving terminal with the user menu configured through the menu configuring unit.

12. The cloud server of claim 11, wherein the user menu is a 3D stereoscopic image.

13. The cloud server of claim 11, wherein the menu behavior pattern comprises a user menu skeleton, menu configuration data and menu control information.

14. The cloud server of claim 11, wherein the menu configuring unit configures the user menu by combining menu behavior pattern information and personalized-menu data.

15. The cloud server of claim 11, wherein the menu providing unit, in response to is the broadcast receiving terminal being turned on, simultaneously provides the broadcast receiving terminal with the menu behavior pattern information and the personalized-menu data.

16. The cloud server of claim 11, wherein the menu providing unit, in response to the broadcast receiving terminal being turned on, provides the broadcast receiving terminal with the menu behavior pattern information and, in response to reception of a user input signal from the broadcast receiving terminal when the broadcast receiving terminal is being implemented, provides the broadcast receiving terminal with the personalized-menu data.

17. The cloud server of claim 11, wherein the menu configuring unit receives from a resource server resources for configuring the user menu and configures the user menu, and the resource comprises at least one of text data, a menu image and video information.

18. A digital broadcasting system, comprising:
a cloud server configured to configure a user menu using a menu behavior pattern;
a broadcast receiving terminal configured to receive the configured user menu from the cloud server to be rendered in a digital TV; and
a resource server configured to provide resources necessary for the cloud server to configure the user menu and for the broadcast receiving terminal to render the user menu.

19. The digital broadcasting system of claim 18, wherein the resource server stores user menu behavior pattern information, personalized-menu data and resources necessary for configuring the user menu and provides the user menu behavior pattern information, the personalized-menu data and the resources for the broadcast receiving terminal through the cloud server.

20. The digital broadcasting system of claim 19, wherein the resource server, in response to the broadcast receiving terminal being turned on, provides the user menu behavior pattern information for the broadcast receiving terminal through the cloud server, in response to reception of a user input signal from the broadcast receiving terminal when the broadcast receiving terminal is being implemented, provides the personalized-menu data for the broadcast receiving terminal through the cloud server, and provides the resource for the broadcast receiving terminal in real-time.
